(19) United States
(12) Patent Application Publication
(10) Pub. No.: US 2013/0116606 A1
(43) Pub. Date: May 9, 2013

(54) METHOD AND DEVICE FOR REDUCING SYMPTOMATIC RELAPSE OF SPASTICITY

(71) Applicant: Paul J. Cordo, Portland, OR (US)

(72) Inventor: Paul J. Cordo, Portland, OR (US)

(73) Assignee: OREGON HEALTH & SCIENCE UNIVERSITY, Portland, OR (US)

(21) Appl. No.: 13/809,453

(22) PCT Filed: Jul. 12, 2011
(86) PCT No.: PCT/US11/43727

§ 371 Date: Jan. 10, 2013

Related U.S. Application Data
(60) Provisional application No. 61/363,571, filed on Jul. 12, 2010.

(51) Int. Cl. A61H 1/00

(52) U.S. Cl. CPC A61H 1/00
USPC 601/46

(57) ABSTRACT

A wearable maintenance therapy device (10, 12, 14) imparts vibratory stimuli to appendicular muscles of a patient's limb during daily life activity of the patient to reduce symptomatic relapse of spasticity. A vibrator actuator (20) contained in a sup port housing (24) and configured for placement in operational contact with appendicular muscles of a limb (28) of a patient imparts localized vibration to one or more of the patient's appendicular muscles. The localized vibration produces proprioceptive input from the vibrated muscle or muscles (90t) to activate sensory areas of the patient's central nervous system. Programmable electrical control circuitry (50) controls vibration characteristics of the localized vibration and includes memory sites for storing operating values of the vibration characteristics. The vibration characteristics include pattern and timing of vibration specified to produce the proprioceptive input during the patient's daily life activity to mitigate any symptomatic relapse of spasticity.

### RELATED APPLICATION

This application claims benefit of U.S. patent application Ser. No. 61/363,571, filed Jul. 12, 2010.

### COPYRIGHT NOTICE

© 2011 Oregon Health & Science University. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This disclosure pertains to the use of a therapy and a device to treat motor disorders that produce dysfunctional patterns of muscle contraction. A wearable device vibrates appendicular muscles of a patient's limb during normal daily life activity to reduce symptomatic relapse of spasticity.

### BACKGROUND INFORMATION

Among the various injuries and disorders affecting volitional movement, a subset of these conditions produces dysfunctional patterns of muscle contraction, including too much involuntary postural muscle tone (i.e., “hypertonia”) and contraction of the wrong muscles during intentional movement (i.e., “dyssynergia”). Symptoms such as these can occur following stroke, traumatic brain injury, cerebral palsy, focal dystonia, spastic paraparesis, and several other disorders. Collectively, this type of motor disorder and the resulting disability affects over 15 million U.S. citizens with annual health care costs over $100 billion.

While a number of rehabilitation therapies for these motor disorders are effective at reducing dysfunctional patterns of muscle contraction during the therapy session, these symptoms relapse over hours-to-days between therapy sessions. Post-therapy relapse may not cause the patient's symptoms to return to their original levels, but the recovery from therapy sessions is incremental, at best, and inefficient in that all or most of the gains achieved during a therapy session are lost before the patient returns to the clinic for the next session.

Muscle vibration is a potent stimulus for la afferents, which are the nerve processes emanating from muscle spindle sensory receptors located in all skeletal muscles. Muscle spindles are a major source of somatic sensory feedback to the brain which feedback provides the sense of body position and movement (i.e., proprioception). Recent studies indicate that muscle vibration, by itself or in combination with specific types of volitional movement, can mitigate the effects of dysfunctional patterns of muscle contraction including hypertonia and dyssynergia. However, like other forms of rehabilitation therapy, the mitigation of symptoms from muscle vibration is not fully sustained after vibration treatment.

### SUMMARY OF THE DISCLOSURE

Improved efficiency of patient rehabilitation therapy, at least where it concerns dysfunctional muscle contraction, reduces the degree of post-therapy relapse with maintenance therapy generated by a wearable device. The wearable maintenance therapy device imparts vibratory stimuli to appendicular muscles of a patient's limb during daily life activity of the patient to reduce symptomatic relapse of spasticity. A vibrator actuator contained in a support housing and configured for placement in operational contact with appendicular muscles of a limb of a patient imparts localized vibration to one or more of the patient's appendicular muscles. The localized vibration produces proprioceptive input from the vibrated muscle or muscles to activate sensory areas of the patient's central nervous system. An attachment device operatively connected to the support housing secures the vibrator actuator in place on the patient's limb. Programmable electrical control circuitry operatively connected to the vibrator actuator controls vibration characteristics of the localized vibration. The programmable electrical control circuitry includes memory sites for storing operating values of the vibration characteristics. The vibration characteristics include pattern and timing of vibration specified to produce the proprioceptive input and thereby activate the sensory areas of the patient's central nervous system during the patient's daily life activity to mitigate any symptomatic relapse of spasticity.

Preferred embodiments of the wearable device are in the form of a bracelet. The wearable device is composed of one or more vibrators that deliver vibration to the patient's skin in contact with the bracelet, or more specifically, to the tissues underlying the skin (i.e., muscles or tendons). The bracelet is positioned on the patient's arm or leg such that the vibration produced by the bracelet stimulates specific muscles, or tendons connected to those muscles. The bracelet is electrically powered, preferably by a rechargeable battery, and controlled by an electrical circuit that determines the timing of vibration (e.g., time of day, duration); pattern and frequency of vibration; and, if multiple vibrators are used, coordination of stimulation between or among the different vibrators. The vibration is delivered automatically and on a prescribed schedule between therapy sessions, thereby maintaining more completely the improved level of motor function achieved during the last rehabilitation session. Maintenance therapy may also be performed to sustain motor function upon the patient's completion of regularly scheduled therapy sessions. The maintenance therapy may require the conscious participation of the patient, depending on which embodiments of the methodology and the device are being used for that patient's maintenance therapy.

As a result of the maintenance therapy, one or both of decreased muscle tone and inappropriate muscle recruitment during volitional movement achieved during a rehabilitation session is better sustained over a longer time. In addition, the application of maintenance vibration to a disabled limb in between rehabilitation sessions may produce additional remittance of hypertonia and dyssynergia above and beyond that achieved from the rehabilitation sessions themselves.

Additional aspects and advantages will be apparent from the following detailed description of preferred embodiments, which proceeds with reference to the accompanying drawings.

### BRIEF DESCRIPTION OF THE DRAWINGS

FIG. 1 is a fragmentary perspective view of a patient's right arm wearing an embodiment of the maintenance therapy device in which a rechargeable battery and a vibrator actuator are located in the same assembly.

FIG. 2 is a fragmentary perspective view of a patient's right arm wearing an embodiment of the maintenance therapy device in which the rechargeable battery is located remotely (e.g., on the upper arm) from the vibrator actuator.

FIG. 3 is a fragmentary perspective view of a patient's right arm wearing an embodiment of the maintenance therapy device in which there is no attached battery and the device connects directly into a power outlet.

FIG. 4 is a perspective view of an embodiment of a vibrator actuator that includes a DC rotary motor having a motor shaft to each end of which is mounted a cam carrying an eccentrically mounted weight.

FIG. 5 is a perspective view of one embodiment of a vibrator actuator that includes a DC rotary motor having a motor shaft to one end of which is mounted a single cam that drives an orthogonally oriented probe shaft by operation of a cam-follower.

FIG. 6 is a perspective view of an embodiment of a vibrator actuator implemented with a voice coil and a drive shaft terminating in and causing linear displacement of an attached probe.

FIGS. 7A, 7B, 7C, and 7D are pictorial diagrams illustrating in cross section a muscle belly or tendons of a patient's limb stimulated by, respectively, one vibrator actuator probe operating on one tendon, two independent vibrator actuator probes operating on different ones of two tendons, one vibrator actuator probe operating on two dependent tendons, and one vibrator actuator probe operating on the belly of one muscle.

### DETAILED DESCRIPTION OF PREFERRED EMBODIMENTS

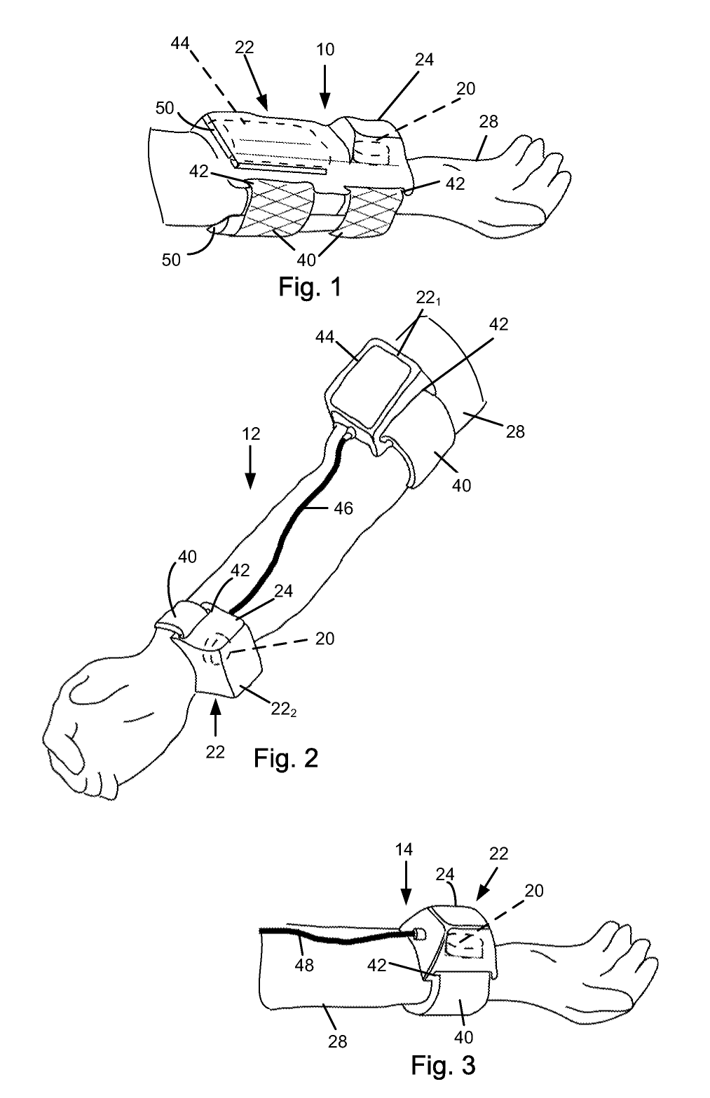

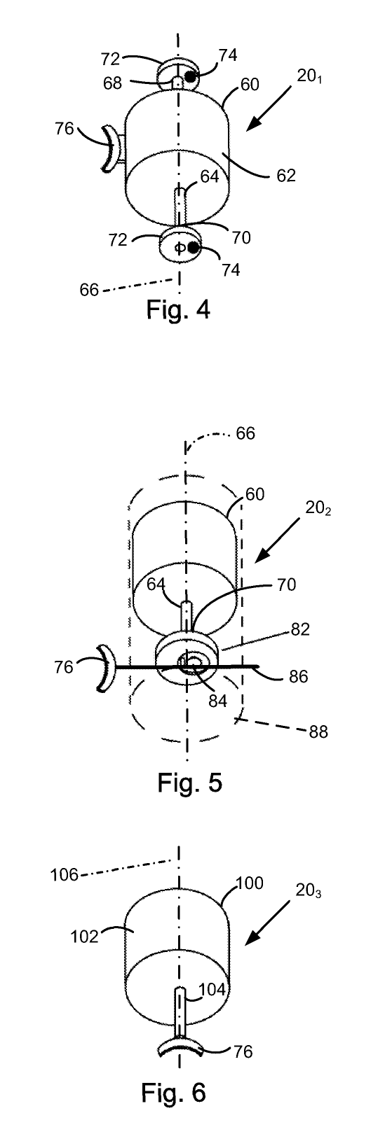

FIGS. 1, 2, and 3 show three portable maintenance therapy device embodiments in the form of bracelets that are capable of imparting vibratory stimuli to the muscles of a patient's limbs. FIGS. 4, 5, and 6 show three alternative embodiments of a vibrator actuator that can be incorporated in any of the therapy device embodiments of FIGS. 1, 2, and 3.

With reference to FIGS. 1, 2, and 3, in each of respective portable maintenance therapy devices 10, 12, and 14, a vibrator actuator 20 mounted to a support member 22 and contained within a support housing 24 is configured for operational contact with appendicular muscles of a limb 28 of a patient. Vibrator actuator 20 is positioned over the desired tendon or muscle in limb 28 and secured in place by an attachment device 40, such as the strap or straps shown passing through slots 42 in support member 22 and wrapping around the patient's limb 28. Vibrator actuator 20 imparts localized vibration to one or more of the appendicular muscles in limb 28 and produces proprioceptive input from the vibrated muscle or muscles to activate sensory areas of the patient's central nervous system. Although they are shown with a single vibrator actuator 20 contained within support housing 24, therapy devices 10, 12, and 14 can be implemented with two or more vibrator actuators 20 contained within a single support housing.

Therapy devices 10, 12, and 14 receive electrical power in different ways. Therapy device 10 of FIG. 1 provides electrical connection to electrical power supplied by a rechargeable battery pack 44 contained within support housing 24. Therapy device 12 of FIG. 2 is constructed with support member 22 provided in two remotely located components 22₁ and 22₂, with support housing 24 being a portion of component 22₂. Therapy device 12 provides by a battery cable 46 electrical connection to electrical power supplied by rechargeable battery pack 44 contained within support component 22₁, which is positioned on the patient's upper arm as shown or positioned elsewhere such as attached to a belt (not shown) around the patient's waist. Therapy device 14 of FIG. 3 provides by a power cord 48 electrical connection to electrical power supplied by an external power outlet (not shown).

In each of therapy devices 10, 12, and 14, programmable electrical control circuitry 50 contained in or electrically connected to support member 22 controls the vibration characteristics of the localized vibration imparted by vibrator actuator 20. Circuitry 50 receives electrical power by rechargeable battery pack 44 or an external power outlet as described above. Circuitry 50 preferably includes a processor or an application specific integrated circuit (ASIC) cooperating with memory sites in which medical practitioner-prescribed operating values of the vibration characteristics are stored. The processor or ASIC provides operational control signals to vibrator actuator 20 to vibrate the patient's muscle in accordance with the stored operating values. The vibration characteristics stored include pattern and timing of vibration specified to produce the proprioceptive input and thereby activate the sensory areas of the patient's central nervous system during the patient's daily life activity to mitigate any symptomatic relapse of spasticity. The timing of vibration includes duration of a period of vibration and temporal spacing between periods of vibration, resulting in establishing frequency of vibration and a number of vibration periods taking place in one day. For example, episodes of severe spasticity would be treated with a longer total time of vibration each day.

Preferred implementations of devices 10, 12, and 14 and the therapy method differ in terms of the pattern and frequency of vibration, which muscles are vibrated, and what the patient does during the vibration. During the maintenance therapy with the device, the pattern of vibration may be either continuous or intermittent (e.g., 3 seconds on and 3 seconds off). The frequency of vibration may be set to values between 20-80 pulses/second, although most commonly to a frequency of 60 pulses/second. Vibration may be applied indirectly to a muscle via its tendon or directly to a muscle, but preferably to a hypertonic muscle or to the muscle functionally antagonistic to a hypertonic muscle. In one implementation of the device, a single vibrator is positioned over a single muscle or group of closely associated muscles, either directly or via their tendons, and in another implementation, two or more vibrators contained in a bracelet are positioned over and deliver mechanical vibration to muscles or their tendons on different sides of a joint. In a further implementation, multiple bracelets stimulate muscles or their tendons at different joints of a limb in a coordinated manner (e.g., simultaneously or separately). In one implementation of the therapy method, the patient keeps the limb relaxed during a continuous pattern of vibration, or in another implementation of the therapy method, the patient volitionally moves the appendicular joint associated with vibrated muscles in time to an intermittent pattern of vibration delivered to one or more muscles or muscle groups.

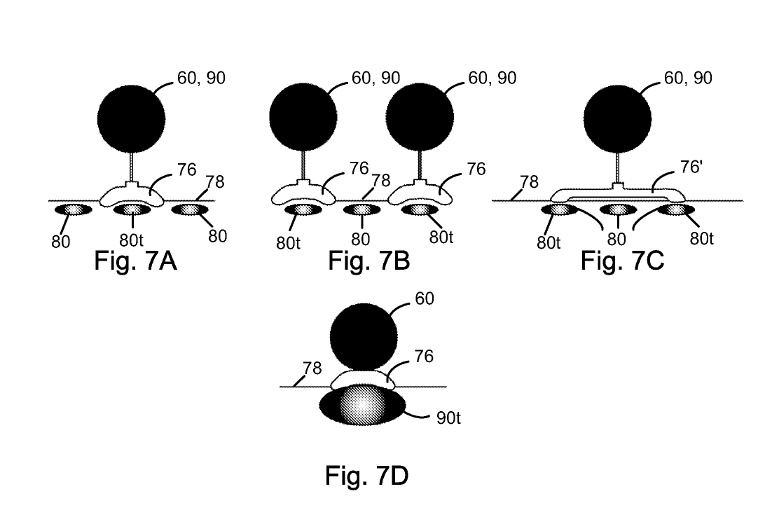

FIGS. 4, 5, and 6 show three alternative embodiments of vibrator actuator 20. Vibrator actuator 20₁ of FIG. 4 shows a DC rotary motor 60 having a cylindrical motor body 62 and a motor shaft 64 that is rotatable about an axis of rotation 66. Motor shaft 64 has opposite ends 68 and 70, and a cam 72 is attached to at least one of them. One or both of cams 72 carry a weight 74 (two weight-carrying cams 72 shown in FIG. 4) attached eccentrically such that rotation of cams 72 by operation of rotary motor 60 causes motor body 62 to vibrate at a frequency equal to the speed of rotation (i.e., revolutions per second) of cams 72. Weights 74 provide a rotationally nonuniform weight distribution that causes motor body 62 to vibrate as motor shaft 64 rotates. A probe 76 attached to the side of motor body 62 can be placed in contact with the surface of skin 78 overlying a patient's tendon 80 to reduce localized vibration of only a target tendon 80t, as shown in FIG. 7A. If the vibration is intended to be distributed more generally around the contact point of vibrator actuator 20₁ and the skin, probe 76 may not be required. The energizing signal developed by circuitry 50 to produce a constant-frequency vibratory motion of vibrator actuator 20₁ is a constant voltage, and the magnitude of voltage characterizing the energizing signal determines the frequency of vibration imparted to target tendon 80t (or to attached muscle).

Vibrator actuator 20₂ of FIG. 5 includes DC rotary motor 60 having motor body 62 and motor shaft 64. A cam 82 is mounted to end 70 of motor shaft 64. A cam follower 84 is seated in cam 82, from which projects a probe shaft 86 of probe 76. Cam follower 84 is set in offset relationship to axis of rotation 66 and thereby forms an eccentric cam arrangement. When motor shaft 64 rotates about axis of rotation 66, cam 82 correspondingly rotates and thereby causes probe shaft 86 to move repetitively in alternate directions along a path orthogonal to axis of rotation 66. In the configuration shown in FIG. 5, probe shaft 86 moves repetitively to the right and left. Vibrator actuator 20₂ of FIG. 5 is housed within an external enclosure 88 (shown in phantom lines), preferably of cylindrical shape and constructed from a rigid material (e.g., plastic or metal). External enclosure 88 has two holes (not shown) through which probe shaft 86 passes so that it remains properly aligned with motor shaft 64 while DC rotary motor 60 is energized and its motor shaft 64 rotates. Probe 76 is attached to the free end of probe shaft 86 and is placed in contact with one or more target tendons 86t so as to impart localized vibration to that target tendon or to those target tendons 86t. The energizing signal required to produce a constant-frequency vibrating motion of vibrator actuator 20₂ is a constant voltage, and the magnitude of voltage characterizing the energizing signal determines the frequency of vibration imparted to the target muscle 90t (FIG. 7D) or target tendon or tendons 80t. An optional tachometer (not shown) may be attached to DC rotary motor 60 and used to control precisely the frequency of vibration imparted to target muscle 90t or target tendon or tendons 80t.

Vibrator actuator 20₃ of FIG. 6 includes a voice coil actuator and functions as a linear motor 100. Linear motor 100 has a motor body 102 and a motor shaft 104 that moves along a longitudinal axis 106 in-and-out of motor body 102 when linear motor 100 is energized. To develop vibratory action of motor shaft 104, the energizing signal produced by circuitry 50 contains the shape of the vibratory pattern (i.e., a square-wave or sinusoid) with repetition of that vibrator pattern at the desired frequency of vibration. Probe 76 is attached to the free end of motor shaft 104 and is placed in contact with one or more target tendons 80t so as to impart localized vibration to that tendon or to those tendons 80t.

FIGS. 7A, 7B, 7C, and 7D present several configurations of probes 76 and 76′ and vibrator actuators 20 by which vibration can be imparted in either a localized manner to one or more target tendons 80t (FIG. 7A, 7B, and 7C) or a localized manner to the belly of muscle 90t (FIG. 7D). With reference to FIGS. 7A, 7B, and 7C, applying vibration to one or more tendons 80t entails transmitting localized vibration to only the muscle or muscles (not shown) attached to target tendons 80t but transmitting no vibration to any other muscle or muscles not attached to the target tendons 80t (e.g., FIG. 7A). FIG. 7A shows a single vibrator actuator 20 configured to apply vibration to a single target tendon 80t underlying the patient's skin 78 in contact with probe 76. FIG. 7B shows two vibrator actuators 20 configured to apply vibration independently to two independent target tendons 80t, for example, so that the two target tendons 80t can be vibrated at different times or at the same time but at different frequencies. FIG. 7C shows a single vibrator actuator 20 with a single probe 76′ that is shaped to contact skin 78 and more than one underlying target tendon 80t but no other intervening tendons 80 so that target tendons 80t underlying skin 78 in contact with probe 76′ are vibrated dependently. Vibrator actuators 20 in FIGS. 7A, 7B, and 7C are preferably those depicted in FIG. 5 (vibrator actuator 20₂) and FIG. 6 (vibrator actuator 20₃). FIG. 7D shows a single vibrator positioned so as to place probe 76 in contact with skin 78 overlying the belly of target muscle 90t and thereby impart vibration directly to it, rather than indirectly via an attached tendon (not shown). Vibrator actuator 20 employed in FIG. 7D is preferably that depicted in FIG. 4 (vibrator actuator 20₁) and is used preferably when target muscle 90t has no distinct tendon or lies deep within limb 28 underneath other muscles 102 such that the attached tendon is not accessible.

The following two prophetic examples demonstrate practice of the disclosed method in two of many possible situations.

### EXAMPLE 1

A 34 year-old female patient, 10 weeks post-stroke, with severe paresis and joint rigidity in her right wrist and fingers, is treated by an occupational therapist with conventional rehabilitation methods in the clinic as part of standard outpatient therapy. The patient's wrist and fingers are paretic and spastic in the flexion direction and clinically plegic in the extensor direction. After 30 minutes of joint ranging, assisted motion, and muscle stimulation with a physiotherapy vibrator, the affected arm and hand are looser and the patient is able to open the hand slightly. The patient returns to the clinic 3 days later for her next therapy session without having used the affected hand for daily activities in the interim. The occupational therapist finds the patient's hand, once again, to be tightly clenched and the patient unable to extend her fingers. This process of recovery in the clinic and relapse at home repeats during the patient's period of outpatient therapy. The physician, alerted to this occurrence, subsequently prescribes the maintenance therapy device described above, which is programmed to vibrate, for 5 minutes each hour, the patient's forearm flexor tendons that originate from the spastic muscles. This maintenance therapeutic regimen is repeated every hour from the time the patient straps on the maintenance therapy device in the morning until she removes it in the evening before retiring to bed. When the patient returns to the clinic for the next therapy session, the occupational therapist finds the patient's hand to have remained loose and the fingers still able to extend slightly. Therefore, by the end of the current therapy session, the patient's condition improves to a new high, because the starting point for the current therapy session began from a higher level as a result of using the maintenance therapy device between therapy sessions. The patient achieves a higher level of recovery than she would have otherwise achieved because of the use of maintenance therapy supplemental to her outpatient therapy.

### EXAMPLE 2

A 48 year-old male individual has been diagnosed with essential tremor, presumably inherited from his mother who had suffered from the disorder for the last 30 years of her life. As with most sufferers of essential tremor, none of the therapeutic approaches tried by clinicians, including antispasmodics or deep-brain stimulation, has been found to significantly mitigate the tremor. A physician prescribes the maintenance therapy device described above for the individual, and the device is programmed to apply vibration to both sides of the wrist on a schedule of 5 minutes of flexor vibration followed by 5 minutes of extensor vibration. This protocol is repeated every 90 minutes, and during each period of vibration, the user need only relax the stimulated arm. After 8 weeks of this daily regimen, the tremor abates in the patient's hand. The physician, upon observing this mitigation of symptoms, changes the treatment regimen to one of maintenance, whereby stimulation takes place for 10 minutes (5 minutes flexion, 5 minutes extension) as before, but only once in the morning and once in the evening. The physician confirms that this maintenance regimen is sufficient to hold the tremor at low levels; and the individual is now able to use the affected arm to eat, to type on a computer keyboard, and to shoot accurately with a bow and arrow.

It will be obvious to those having skill in the art that many changes may be made to the details of the above-described embodiments without departing from the underlying principles of the invention. The scope of the present invention should, therefore, be determined only by the following claims.

1. A wearable maintenance therapy device adapted to impart vibratory stimuli to appendicular muscles of a patient's limb during daily life activity of the patient to reduce symptomatic relapse of spasticity, comprising:
a vibrator actuator contained in a support housing and configured for placement in operational contact with appendicular muscles of a limb of a patient to impart localized vibration to one or more of the patient's appendicular muscles, the localized vibration producing proprioceptive input from the vibrated muscle or muscles to activate sensory areas of the patient's central nervous system;
an attachment device operatively connected to the support housing to secure the vibrator actuator in place on the patient's limb; and
programmable electrical control circuitry operatively connected to the vibrator actuator to control vibration characteristics of the localized vibration, the programmable electrical control circuitry including memory sites for storing operating values of the vibration characteristics including pattern and timing of vibration specified to produce the proprioceptive input and thereby activate the sensory areas of the patient's central nervous system during the patient's daily life activity to mitigate any symptomatic relapse of spasticity.

2. The maintenance therapy device of claim 1, further comprising an electrical connection to provide electrical power for operating the vibrator actuator and the programmable electrical control circuitry.

3. The maintenance therapy device of claim 2, further comprising a support member of which the support housing is a portion and which holds a battery functioning as a source of the electrical power, and in which the electrical connection is made on or within the support.

4. The maintenance therapy device of claim 2, further comprising a first support member component of which the support housing is a portion, a second support member component configured for attachment to the patient's limb and including a battery pack functioning as a source of the electrical power, and a battery cable forming the electrical connection.

5. The maintenance therapy device of claim 2, in which the electrical connection is a power cord adapted for connection into a power outlet.

6. The maintenance therapy device of claim 1, in which the vibrator actuator comprises:
a rotary motor including a motor body and a motor shaft rotatable about an axis of rotation and having an end;
a weight operatively connected to the end and configured to provide a rotationally nonuniform weight distribution that causes the motor body to vibrate as the motor shaft rotates; and
a probe operatively connected to the motor body to impart the localized vibration in response to rotation of the motor shaft about the axis of rotation.

7. The maintenance therapy device of claim 6, in which the end is a first end and the motor shaft has a second end positioned opposite the first end, in which the weight is a first weight, and further comprising a second weight operatively connected to the second end and configured to contribute to the rotationally nonuniform weight distribution.

8. The maintenance therapy device of claim 1, in which the vibrator actuator comprises:
a rotary motor including a motor shaft rotatable about an axis of rotation and having an end;
a cam mounted to the end of the motor shaft; and
a probe having a probe shaft attached to a cam follower seated in the cam, the probe shaft positioned in transverse relation to the axis of rotation so that, in response to rotation of the motor shaft, the probe moves repetitively in alternate directions along a path that is orthogonal to the axis of rotation to impart the localized vibration.

9. The maintenance therapy device of claim 1, in which the vibrator actuator comprises:
a linear motor including a motor shaft movable along a longitudinal axis and having an end; and
a probe attached to the end of the motor shaft in a position to move along the longitudinal axis to impart the localized vibration in response to movement of the motor shaft.

10. The maintenance therapy device of claim 9, in which the linear motor includes a voice coil actuator.

11. A method of mitigating symptomatic relapse of spasticity experienced by a patient during daily life activity, comprising:
mounting, in position for operational contact with appendicular muscles of a limb of a patient, a vibrator actuator to impart localized vibration to one or more of the patient's appendicular muscles, the localized vibration producing proprioceptive input from the vibrated muscle or muscles to activate sensory areas of the patient's central nervous system; and
activating electrical control circuitry operatively connected to the vibrator actuator to control vibration characteristics of the localized vibration, the electrical control circuitry including memory sites in which are stored operating values of the vibration characteristics including pattern and timing of vibration specified to produce the proprioceptive input and thereby activate sensory areas of the patient's central nervous system to mitigate any symptomatic relapse of spasticity.

12. The method of claim 11, in which the appendicular muscles are attached to associated tendons, and in which the vibrator actuator imparts localized vibration indirectly to the vibrated muscle or muscles via their associated tendon or tendons.

13. The method of claim 11, in which the vibrator actuator imparts localized vibration directly to the vibrated muscle or muscles.
